(19) United States
(12) Patent Application Publication
(10) Pub. No.: US 2020/0027625 A1
(43) Pub. Date: Jan. 23, 2020

(54) TRANSPARENT CONDUCTIVE FILM AND THEMETHOD OF MAKING THE SAME

(71) Applicant: Nano and Advanced Materials Institute Limited, Hong Kong (HK)

(72) Inventors: Yubin XIAO, Hong Kong (HK); Jianjun SONG, Hong Kong (HK); Paul Kwok Keung HO, Hong Kong (HK)

(21) Appl. No.: 16/483,757

(22) PCT Filed: May 15, 2018
(86) PCT No.: PCT/CN2018/086839

§ 371 Date: Aug. 6, 2019

Related U.S. Application Data
(60) Provisional application No. 62/602,993, filed on May 15, 2017.

(51) Int. Cl. H01B 1/22; C03C 17/10

(52) U.S. Cl. CPC H01B 1/22; H05B 33/28; C03C 17/10

(57) ABSTRACT

A self-assembled metal mesh transparent conductive film and the method of fabricating the same are provided in the present invention. Some key aspects of the present invention are as follows: 1) to control the opening size in self-assembled metal mesh transparent conductive film; 2) to tune the surface energy of substrate using surface treatment; 3) to improve transparency of metal mesh by low-temperature method such as chemical etching; 4) to increase the conductivity of metal mesh without high temperature annealing; and 5) to strengthen the metal mesh film by post-treatment. The transparent conductive film of the present invention can be formed on rigid or flexible substrates. The present method enables tuning the transparency and conductance of the metal mesh film through tuning the opening size of metal mesh, and is also cost-effective due to low process cost and high material utilization rate.

### CROSS-REFERENCE TO RELATED APPLICATIONS

This application is a 371 application of PCT Application No. PCT/CN2018/086839 filed May 15, 2018, which claims priority from U.S. provisional patent application Ser. No. 62/602,993 filed May 15, 2017, and the disclosures of which are incorporated herein by reference in their entirety.

### FIELD OF INVENTION

The present invention relates to a method of preparing a transparent conductive film with self-assembled metal mesh having a controlled opening size resulting in high transparency and low sheet resistance. The present method is applicable to both rigid and flexible substrate.

### BACKGROUND

Transparent conductive films (TCFs) with high transparency to let light to pass through and high conductivity to provide electrical contact to the active layer, are widely used in displays, LED lighting, thin film solar cells and other electronics with increasingly large industry demands. The key parameters that determine the applications of transparent conductive film include the sheet resistance, the optical transparency, the flexibility and the cost.

Indium-doped Tin oxide (ITO) has an established value chain and dominates the current TCF market, with applications in most of the touch screens and electronic displays manufactured today, including LCDs and OLEDs for cell phones, laptops, TV sets, digital signs, and public information displays. ITO has advantages including the matured manufacturing process (physical vapor deposition and photolithography patterning) and good transparency (around 90%). However, ITO as a TCF also has its performance limitations like high cost and brittleness. These limitations and emergence of new applications drove intensive studies on various ITO replacements in recent years.

In general, these replacements should have low sheet resistance to allow fast response and low power consumption, high transparency for good viewability, high flexibility to be bendable and low cost to offer a lower priced device. Metal mesh is a regular or random irregular grid formed by nanoparticles. Metal mesh usually has high conductivity due to highly conductive metal nanoparticles and high transparency due to large open areas which are not covered by opaque metal electrode. One way to form metal mesh is by self-assembling of metal nanoparticles on substrates, this method enjoys low process cost and no Moire effect. One challenge of the self-assembled metal mesh is to tune the mesh opening size to tune the film transparency and conductance. In addition, efforts are also needed to develop more efficient way for metal mesh transparent conductive film patterning, which is usually costly and a weakness for most TCFs.

### SUMMARY OF INVENTION

One objective of this invention is to provide a method for fabricating a transparent conductive film (TCF) comprising: providing a mixed solution comprising a dispersed liquid phase, a continuous liquid phase, at least one emulsifier, metal nano-particles, and additives, wherein said at least one emulsifier and/or one of said additives is/are added into said mixed solution in a concentration range or weight percentage range which leads to said opening size of the self-assembled metal mesh; pre-treating a surface of the substrate to produce a hydrophilic or hydrophobic interface between said surface of the substrate and said mixed solution to be coated thereon; coating said mixed solution on to said surface of the substrate to form a wet film in a manner that the thickness of the wet film is controlled within a range which leads to said opening size of the self-assembled metal mesh; drying said wet film to remove the solvent and liquid phase until a dried film is formed; treating dried film under heat, by chemical etching, superheated vapor, photonic sintering, or a combination thereof, to improve conductivity and transparency of the metal mesh.

In an exemplary embodiment, the opening size of the metal mesh is from 20 to 50 μm. Because the metal mesh is self-assembled, the formation of the mesh-like pattern of the metal mesh is affected by the surface property including the surface energy where the metal mesh is formed thereon. To control and/or modify the surface property of the substrate, said pre-treating of the substrate surface is performed in the present method. In one embodiment, the surface treatment of the substrate is performed by using plasma or UV illumination. In other embodiment, the surface of the substrate is coated by a polymer which has hydrophilic or hydrophobic group. By these ways, the selectivity of the mesh-like pattern formation on the substrate can be improved.

Conductivity of said metal mesh or the overall transparent conductive film of the present invention can be improved by superheated vapor treatment, photonic treatment, chemical treatment, or a combination thereof.

In the present method, said coating of the mixed solution on to the pre-treated surface of the substrate can be done by various coating methods including but not limited to Meyer rod coating, blade coating, screen printing, spray coating, and slot die coating, etc., where slot die coating is preferred in some embodiments. After said coating, the substrate can be kept at room temperature for drying or heated to let the liquid phases to evaporate from the substrate. During the drying process, the solvents will dry out and nano-particles in the mixed solution will be self-assembled to form the conductive mesh-like metal pattern which is transparent to visible light. The transparent conductive film fabricated according to the present method can reach at least 75% visible light transmittance. More preferably, it can reach over 80% visible light transmittance.

To improve the transparency of the transparent conductive film, etching such as chemical etching, plasma dry etching, or a combination thereof, can be employed to remove residual opaque materials such as metal nano-particles after self-assembly of the mesh-like pattern.

This Summary is intended to provide an overview of the present invention and is not intended to provide an exclusive or exhaustive explanation.

### BRIEF DESCRIPTION OF THE DRAWINGS

Embodiments of the present invention are described in more detail hereinafter with reference to the drawings, in which:

FIG. 1A is an SEM image of the transparent conductive film fabricated according to an embodiment of the present method, where the wet film thickness of 40 μm was used;

FIG. 1B is an SEM image of the transparent conductive film fabricated according to an embodiment of the present method, where the wet film thickness of 60 μm was used;

FIG. 1C is an SEM image of the transparent conductive film fabricated according to an embodiment of the present method, where the wet film thickness of 120 μm was used;

FIG. 2A is an SEM image of the transparent conductive film fabricated according to an embodiment of the present method, where 2% w/w Span-60 was used;

FIG. 2B is an SEM image of the transparent conductive film fabricated according to an embodiment of the present method, where 3% w/w Span-60 was used;

FIG. 2C is an SEM image of the transparent conductive film fabricated according to an embodiment of the present method, where 4% w/w Span-60 was used;

FIG. 3A is an SEM image of the transparent conductive film fabricated according to an embodiment of the present method, where 0.01% w/w APTES was used;

FIG. 3B is an SEM image of the transparent conductive film fabricated according to an embodiment of the present method, where 0.1% w/w APTES was used;

FIG. 3C is an SEM image of the transparent conductive film fabricated according to an embodiment of the present method, where 1% w/w APTES was used;

FIG. 3D is an SEM image of the transparent conductive film fabricated according to an embodiment of the present method, where 3% w/w APTES was used;

FIG. 3E is an SEM image of the transparent conductive film fabricated according to an embodiment of the present method, where 7% w/w APTES was used;

FIG. 4A is an SEM image of the transparent conductive film fabricated according to an embodiment of the present method before etching;

FIG. 4B is an SEM image of the transparent conductive film fabricated according to an embodiment of the present method after etching.

### DETAILED DESCRIPTION OF INVENTION

The present invention is not to be limited in scope by any of the following descriptions. The following examples or embodiments are presented for exemplification only.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Definitions

The singular forms “a,”, “an” and “the” can include plural referents unless the context clearly dictates otherwise.

The term “about” can allow for a degree of variability in a value or range, for example, within 10%, or within 5% of a stated value or of a stated limit of a range.

The term “independently selected from” refers to referenced groups being the same, different, or a mixture thereof, unless the context clearly indicates otherwise. Thus, under this definition, the phrase “X1, X2, and X3 are independently selected from noble gases” would include the scenario where, for example, X1, X2, and X3 are all the same, where X1, X2, and X3 are all different, where X1 and X2 are the same but X3 is different, and other analogous permutations.

### DESCRIPTION

The present invention provides a method for fabricating transparent conductive film with a controlled opening size of a self-assembled metal mesh from 20 to 50 μm formed on a substrate such that the overall visible light transmittance and sheet resistance of the transparent conductive film are at least 75% and not greater than 10 ohms/square, respectively. To fabricate said transparent conductive film, the present method comprises providing a mixed solution (or “ink formulation”/“emulsion formulation” used herein interchangeably) including a dispersed liquid phase (or “water phase” used herein interchangeably), a continuous liquid phase (or “organic phase” used herein interchangeably), a plurality of metal nano-particles capable of being self-assembled to form metal mesh-like pattern on a substrate when the liquid phases are evaporated during a drying step in the present method, one or more surfactants (or “emulsifier” used herein interchangeably), one or more additives dissolvable in the dispersed or continuous liquid phase or both including rheology modifiers, stabilizers, thickeners, and/or wetting agents. The mixing of different components in the emulsion formulation can be achieved by one-step or multi-step mixing such as high-speed magnetic stick mixing, high frequency vibration, ultrasonic homogenizer mixing, or any combination thereof.

Depending on the emulsifier or surfactant to be used in the emulsion formulation, the two liquid phases could form water-in-oil or oil-in-water emulsion after said mixing. The continuous liquid phase is composed of organic solvents including toluene, acetic acid, 1-butanol, 2-butanol, carbon tetrachloride, chlorobenzene, chloroform, 1,2-dichloroethane, diethylene glycol, diethylene glycol dimethyl ether, heptane, N-methyl-2-pyrrolidinone, triethyl amine, cyclohexanone, petroleum ether, trichloroethylene or any combination thereof. The dispersed liquid phase is composed of water and/or water miscible solvents including ethanol, isopropanol, ethylene glycol, acetone, ethyl acetate, n-butyl acetate or any combination thereof. The weight ratio of the continuous liquid phase to the disperse liquid phase is in the range of 20:80 and 80:20. The emulsifier can be ionic or non-ionic emulsifier. Said ionic emulsifier is one or both of sodium dodecyl sulfate and lauryldimethylamine oxide. Said non-ionic emulsifier comprises Span-20, Span-40, Span-60, Span-80, Span-85 or any combination thereof. Preferably, Span-60 is selected as an appropriate non-ionic emulsifier in most of the examples. More preferably, the weight percentage of Span-60 is up to 8.0% of the total weight of the emulsion formulation. Most preferably, the weight percentage of Span-60 is from 0.5 to 8.0%.

Suitable rheology modifier being said one or more additives comprises polyether modified siloxane. Preferably, said polyether modified siloxane is BYK 348 or polyethylene glycol with a molecular weight of about 400 to 8,000 Da, and more preferably, the weight ratio of BYK 348 in the dispersed liquid phase or the water phase is up to 5%; or the weight ratio of polyethylene glycol is from 1 to 5% to the total weight of the continuous liquid phase. More preferably, the weight ratio of BYK 348 is from 2 to 5%.

The metal nano-particles can be one or more conductive metals including silver, copper, gold, platinum, nickel, carbon or any combination thereof. Besides the conductive metals mentioned above, other conductive metal compounds, e.g., metal oxides such as ITO, IZO, AZO, FTO, or the combination thereof, can be used. Non-metal conductive material, e.g., conductive polymers such as PEDOT:PSS, can also be used to form the conductive part of the transparent conductive film.

The substrate where the emulsion formulation is coated on can be rigid or flexible substrate. For rigid substrate, suitable candidates include glass substrate such as quartz and borate glass. For flexible substrate, suitable candidates include Polyethylene terephthalate (PET) and cyclo olefin copolymer (COP).

Before coating said emulsion formulation on to the substrate to form a wet ink layer according to the present method, the surface of the substrate where the emulsion formulation is to be coated on is pre-treated with plasma or by coating a polymer having a hydrophilic or hydrophobic group to modify the surface property, especially the surface energy, of the substrate for improving the mesh-like pattern to be formed after coating said emulsion formulation on to the substrate. In one embodiment, said plasma can be O₂ or N₂ plasma which produce a hydrophilic or hydrophobic interface between the wet ink layer and the substrate. In other embodiment, the polymer having hydrophilic or hydrophobic group comprises (3-Aminopropyl) triethoxysilane (APTES) and Octadecylphosphonic acid (ODPA). In some examples, diluted APTES in acetone is used as a polymer modifier to modify the substrate surface, and the concentration of APTES used therein ranges from 0.01% to 10% by weight, more preferably 0.1% to 7% by weight.

Coating of the emulsion formulation on to the substrate according to the present method includes by spin coating, Meyer rod coating, spray coating, dip coating, slot die coating, or other suitable coating techniques. In some examples where Meyer rod coating is employed, different Meyer rod sizes can be used to vary the thickness of the wet film from 6 to 200 μm. By controlling the wet film thickness within 40 to 120 μm, the opening size of the metal mesh to be formed can be controlled from 20 to 50 μm.

Table 1 summarizes the relationship between the opening size of the metal mesh and various factors in terms of the examples described hereinafter:

TABLE 1

| | Concentration/ | | Opening | | |
|---|---|---|---|---|---|
| Factors | Thickness | | size | Sheet resistance | |
| Span-60 | 2% | | 15 μm | 1.0 | ohm/sq |
| | 3% | | 20 μm | 0.8 | ohm/sq |
| | 4% | | 25 μm | 0.5 | ohm/sq |
| | 6% | | 40 μm | 0.5 | ohm/sq |
| | 8% | | 50 μm | 0.5 | ohm/sq |
| BYK-348 | 0.5% | | 10 μm | not conductive | |
| | 1.0% | | 20 μm | not conductive | |
| | 2.5% | | 35 μm | 7.0 | ohms/sq |
| | 5.0% | | 45 μm | 5.0 | ohms/sq |
| Film thickness | 40 | μm | 10 μm | Not conductive | |
| | 60 | μm | 25 μm | 7.0 | ohms/sq |
| | 120 | μm | 35 μm | 5.0 | ohms/sq |
| | 150 | μm | 50 μm | 4.0 | ohm/sq |

The present method also includes drying the emulsion formulation after being coated on to the substrate to evaporate both the dispersed and continuous liquid phases away from the emulsion formulation such that only the nano-particles are left on the substrate to self-assemble to form the conductive mesh-like pattern. Said drying can be done at room temperature or by applying heat.

After the formation of mesh-like pattern of the metal mesh on to the substrate, opaque materials, in particular, the residual metal nano-particles outside the connecting mesh networks, can be removed by etching such as chemical etching. In some examples, iron nitrate is applied over the dried coated substrate to remove the residual metal nano-particles on the opening area of the mesh-like pattern. To accelerate the etching process, certain heat is also applied during chemical etching. Removal of opaque materials from the opening area of the metal mesh can improve both transparency and conductivity. In some examples, chemical etching is done by applying iron nitrate solution in the centre of the opening area of the metal mesh. Specifically, Fe(NO₃)₃ is dissolved in water at a concentration of 0.2 g/ml to make the iron nitrate solution and the solution is applied on to the metal mesh for about 10 seconds then removed by rinsing with water. During the application of the iron nitrate solution, heat can be additionally applied, e.g., up to 40° C., in order to speed up the etching process. In the case where the metal mesh is composed of silver, the following chemical reaction is carried out by using iron nitrate solution as the etchant:

Ag+Fe(NO₃)₃→AgNO₃+Fe(NO₃)₂

Photonic sintering can also be applied to treat the metal mesh formed on the film to improve the overall mechanical property. In some examples, the photonic sintering is done by using high frequency pulsed light source with an energy density from 1 to 5 J/cm² for a sintering time from 0.5 to 5.0 ms and such source is placed with a sintering distance between 1 cm and 20 cm away from the metal mesh opening area, more preferably between 4 cm and 8 cm.

Apart from chemical etching and photonic sintering as above mentioned, plasma dry etching or thermal sintering is also feasible for removing opaque materials from the opening area of the metal mesh. In the case of using thermal sintering, the annealing temperature is from 500 to 800° C. However, high temperature sintering is not suitable for flexible substrate and therefore chemical etching or photonic sintering which is with relatively lower processing temperature is more preferred.

To improve the conductivity of the metal mesh, it is also feasible to treat the dried metal mesh formed on the substrate by superheated vapor, photonic sintering and/or formic acid. In one embodiment, the superheated vapor can be water vapor heated up to 200° C., more preferably, from 150 to 200° C. In other embodiment, the acid treatment is carried out by using formic acid or other acids. In another embodiment, the photonic sintering is carried out by using high frequency pulsed light, which has been mentioned above.

Optionally, the present method further includes coating an additional polymer on to the metal mesh formed on the substrate in order to improve the adhesion between the metal mesh and the substrate and to improve the overall mechanical properties. In some examples, the additional polymer coated on to the metal mesh as such is done by spin coating, spray coating, or other suitable coating methods. Preferably, the additional polymer is diluted carboxymethyl cellulose or alike in a solvent such as water and the concentration of diluted carboxymethyl cellulose is from 0.5 to 5.0% w/w, and more preferably, up to 2.0%.

The following examples accompanied with drawings will illustrate the present invention in more detail.

### EXAMPLES

The embodiments of the present invention can be better understood by reference to the following examples which are offered by way of illustration. The present invention is not limited to the examples given herein.

### Example 1

### Effect of Various Wet Film Thicknesses on Opening Size/Conductivity of Metal Mesh

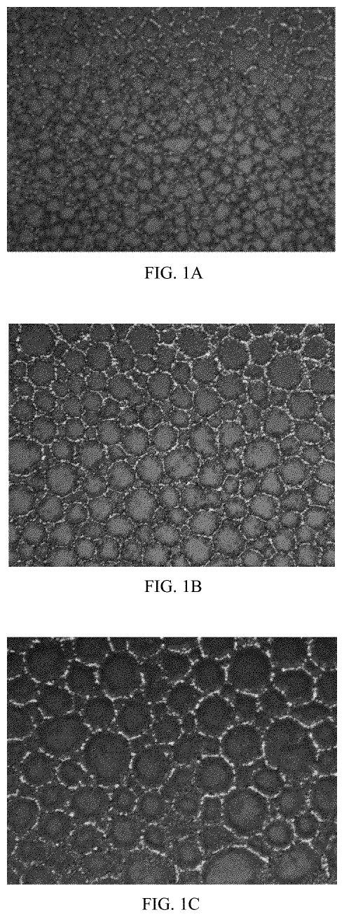

FIGS. 1A-1C are SEM images showing morphology of the mesh-like pattern of the metal mesh formed on the substrate by varying the wet film thickness of the emulsion formulation provided and coated according to certain embodiments of the present invention.

In FIG. 1A, the emulsion formulation for forming a wet film on the glass including 8% of Span-60, 3% BYK 348, 20% water, 63% of toluene, 4% of Ag nanoparticles is coated by Meyer rod coating on to the substrate until the wet film thickness of 40 μm is reached. After drying the emulsion formulation at room temperature to evaporate the solvents away, mesh-like pattern is formed and the opening size of the formed metal mesh is measured under the SEM. In this example, the opening size of 10 μm of the metal mesh is obtained, and no conductivity is detected.

In FIG. 1B, the wet film is formed by coating the same emulsion formulation on to the same substrate as in FIG. 1A but the wet film thickness in this example is 60 μm. By using this wet film thickness, an opening size of 25 μm of the metal mesh and sheet resistance of 7 ohms/sq are obtained in this example. When the wet film thickness is increased to 120 μm, an opening size of 35 μm of the metal mesh and sheet resistance of 5 ohms/sq are obtained, the morphology of the metal mesh being shown in FIG. 1C. From these examples where the wet film thickness varies, the opening size of the metal mesh formed on to the substrate and the overall sheet resistance can vary accordingly, but the minimum wet film thickness in these examples should be more than 40 μm in order to reach the desirable opening size range of 20 to 50 μm, leading to a sheet resistance of not more than 10 ohms/sq.

### Example 2

### Effect of Various Concentrations of Emulsifier on Opening Size/Conductivity of Metal Mesh

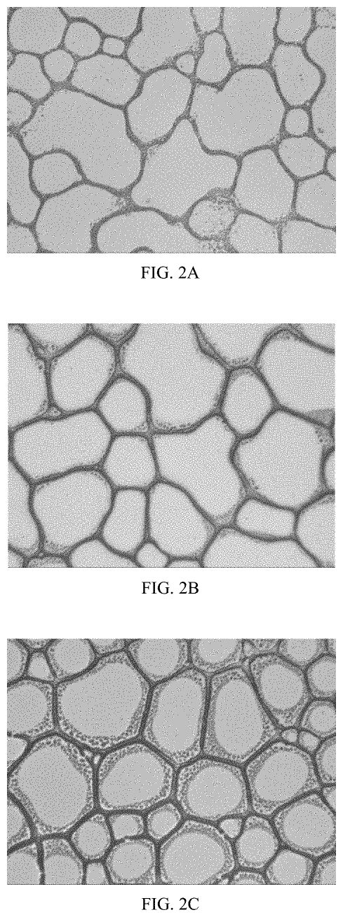

FIGS. 2A-2C are SEM images showing morphology of the mesh-like pattern of the metal mesh formed on the substrate by varying the concentration of emulsifier used in the emulsion formulation provided and coated according to certain embodiments of the present invention.

In FIG. 2A, the emulsion formulation for forming a wet film on the glass substrate including 2% of Span-60, 4% BYK 348, 25% water, 65% of toluene, 4% of Ag nanoparticles is coated by Meyer rod coating at a wet film thickness of 120 μm. By using 2% Span-60 in the emulsion formulation, an opening size of 15 μm of the metal mesh formed on to the substrate and a sheet resistance of 1.0 ohm/sq are obtained. By increasing the concentration of Span-60 used in the emulsion formulation and keeping the rest of the conditions unchanged, an opening size of 20 μm of the metal mesh formed on to the substrate and a sheet resistance of 0.8 ohm/sq are obtained, the morphology thereof being shown in FIG. 2B. By further increasing the concentration of Span-60 to 4%, an opening size of 25 μm of the metal mesh formed on to the substrate and a sheet resistance of 0.5 ohm/sq are obtained, the morphology thereof being shown in FIG. 2C.

### Example 3

### Effect of Various Polymer Modifier for Pre-Treating Substrate on Formation of Mesh-Like Pattern of Metal Mesh

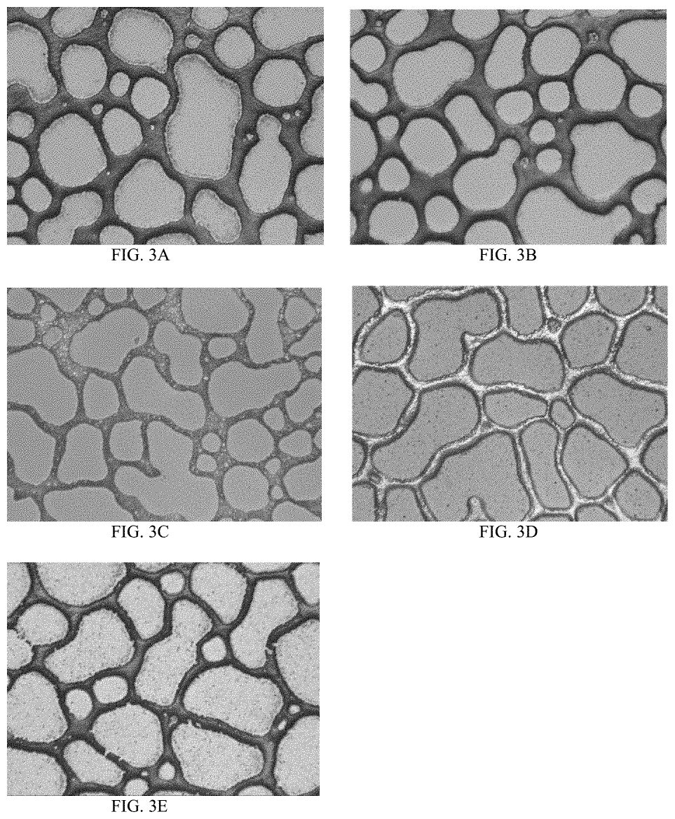

FIGS. 3A-3E are SEM images showing morphological change of the mesh-like pattern formed by varying the concentration of the polymer, APTES, for modifying the surface property of the polyethylene terephthalate (PET) substrate before the emulsion formulation including 3% of Span-60, 4% BYK 348, 25% water, 65% of toluene, 3% of Ag nanoparticles is coated by Meyer rod coating at a wet film thickness of 120 μm.

In FIG. 3A, 0.01% APTES is applied to be coated on to the substrate for enhancing the hydrophilicity of the substrate before the emulsion formulation is coated thereon.

From FIGS. 3B-3E, the concentration of APTES is increased from 0.1% to 7%, and the morphology of the metal mesh observed from the corresponding SEM images is getting more regular and intact. From these SEM images, an increase in opening size from 50 to 100 μm, a sheet resistance of about or less than 1 ohm/sq, and an increase in visible light transmittance from about 70% to about 80% are observed.

### Example 4

### Effect of Chemical Etching on Transparency/Conductivity of Metal Mesh

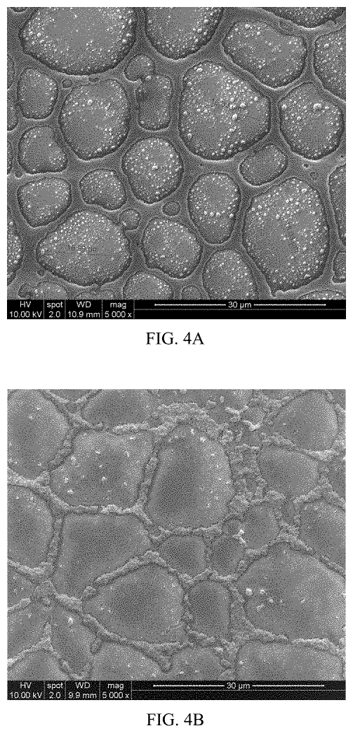

FIG. 4A is an SEM image of the sample obtained by Meyer rod coating the emulsion formulation including 6% of Span-60, 3% BYK 348, 22% water, 63% of toluene, 6% of Ag nanoparticles at a wet film thickness of 150 μm on to the glass followed by drying at room temperature until all solvents are evaporated and mesh-like pattern is formed. An opening size of about 20 μm, a sheet resistance of 1 ohm/sq and visible light transmittance of 65% are obtained from this sample without any etching after drying.

FIG. 4B is an SEM image of the sample obtained according to the same method and emulsion formulation as in FIG. 4A, except an additional etching step following the drying step is carried out by applying 0.2 g/ml iron nitrate solution on to the centre of the opening area of the metal mesh and incubated for 10 seconds at about 40° C. After the incubation, the residual solution is washed away by water and subject to different measurements. An opening size of about 25 μm, a sheet resistance of 7 ohms/sq and visible light transmittance of 76% are obtained in this sample having been etched by chemicals.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### INDUSTRIAL APPLICABILITY

The present invention is an easy scalable method for tuning the properties of the self-assembled metal mesh formed on any suitable substrate for fabricating transparent conductive film, in particular, on flexible substrate, because the materials normally used for the flexible substrate in this area cannot withstand high annealing temperature for sintering, and therefore the present invention provides a method for fabricating the same without high temperature sintering.

1. A method for fabricating a transparent conductive film with a self-assembled metal mesh having an opening size of about 20 to about 50 μm in said transparent conductive film formed on a substrate, comprising:
providing a mixed solution comprising a dispersed liquid phase, a continuous liquid phase, at least one emulsifier, a plurality of metal nano-particles, and one or more additives, wherein said at least one emulsifier and/or one of said additives is/are added into said mixed solution in a concentration or weight ratio which leads to said opening size of the self-assembled metal mesh;
pre-treating a surface of the substrate to produce a hydrophilic or hydrophobic interface between said surface of the substrate and said mixed solution to be coated thereon;
coating said mixed solution on to said surface of the substrate to form a wet film in a manner that the thickness of the wet film is controlled within a range which leads to said opening size of the self-assembled metal mesh;
drying said wet film to remove the solvent and liquid phase until a dried film is formed;
treating dried film under heat, by chemical etching, superheated vapor, photonic sintering, or a combination thereof, to improve conductivity and transparency of the metal mesh.

2. The method of claim 1, wherein said dispersed liquid phase comprises water, ethanol, isopropanol, ethylene glycol, acetone, ethyl acetate, n-butyl acetate or any combination thereof.

3. The method of claim 1, wherein said continuous liquid phase comprises toluene, acetic acid, 1-butanol, 2-butanol, carbon tetrachloride, chlorobenzene, chloroform, 1,2-dichloroethane, diethylene glycol, diethylene glycol dimethyl ether, heptane, N-methyl-2-pyrrolidinone, triethyl amine, cyclohexanone, petroleum ether, trichloroethylene or any combination thereof.

4. The method of claim 1, wherein said at least one emulsifier comprises one of ionic and non-ionic emulsifiers.

5. The method of claim 4, wherein said ionic emulsifier comprises Span-20, Span-40, Span-60, Span-80, Span-85, or any combination thereof.

6. The method of claim 4, wherein said non-ionic emulsifier is one or more of sodium dodecyl sulfate and lauryldimethylamine oxide.

7. The method of claim 5, wherein said at least one emulsifier is Span-60.

8. The method of claim 7, wherein said Span-60 is up to 8.0% of the total weight of said mixed solution.

9. The method of claim 1, wherein said additives comprise rheology modifiers, stabilizers, thickener, and wetting agents.

10. The method of claim 9, wherein said rheology modifiers comprise polyether modified siloxane and polyethylene glycol.

11. The method of claim 10, wherein said polyether modified siloxane is BYK 348.

12. The method of claim 11, wherein said BYK 348 is up to 5% of the weight of said continuous liquid phase.

13. The method of claim 10, wherein said polyethylene glycol has a molecular weight of 400 to 8,000 Da and the weight ratio thereof is from 1 to 5% to the total weight of the continuous liquid phase.

14. The method of claim 1, wherein said metal nano-particles are made of one or more conductive metals, metal oxides, or a mixture of metal and non-metal materials comprising silver, copper, gold, platinum, nickel, carbon, ITO, IZO, AZO, FTO, or any combination thereof.

15. The method of claim 1, wherein said thickness of the wet film is from 40 to 150 μm.

16. The method of claim 1, wherein said substrate is rigid or flexible substrate.

17. The method of claim 16, wherein said rigid substrate comprises quartz and borate glass.

18. The method of claim 16, wherein said flexible substrate comprises polyethylene terephthalate (PET) and cyclo olefin copolymer (COP).

19. The method of claim 1, wherein said treating the dried film by heat is performed at a temperature ranging from 500° C. to 800° C. when said substrate is a rigid substrate.

20. The method of claim 1, wherein said chemical etching is by treating the dried film with one or more acids comprising formic acid.

21. The method of claim 1, wherein said chemical etching is by treating the dried film with an iron nitrate solution at a concentration of 0.2 g/ml for about 10 seconds and at a temperature of about 40° C. to remove metal nano-particles residues.

22. The method of claim 1, wherein said superheated vapor is water vapor at a temperature from 150 to 200° C.

23. The method of claim 1, wherein said photonic treatment comprises using high frequency pulsed light at an energy density of 1 to 5 J/cm² with a sintering distance of about 1 to 20 cm from said surface of the substrate for a sintering time of about 0.5 to 5.0 milliseconds.

24. The method of claim 1, further comprising coating a polymer on said dried film to improve adhesion between the metal mesh and the substrate and the mechanical properties thereof, wherein said polymer comprises carboxymethyl cellulose at a concentration from 0.5 to 5.0% in a solvent.

25. The method of claim 24, wherein said polymer is coated on said dried film by spin coating or spray coating at a concentration of up to 2.0% in water.

26. The method of claim 1, wherein said pre-treating comprises of one or more of plasma, UV illumination, and/or coating of a polymer.

27. The method of claim 26, wherein said plasma comprises O₂ or N₂ plasma.

28. The method of claim 26, wherein said polymer comprises (3-Aminopropyl) triethoxysilane and Octadecylphosphonic acid.

29. The method of claim 1, wherein said coating the mixed solution on to the surface of the substrate is by spin coating, Meyer rod coating, spray coating, dip coating, or slot die coating.

30. The method of claim 1, wherein the weight ratio of said dispersed liquid phase to said continuous liquid phase is from 80:20 to 20:80.

31. A transparent conductive film formed on a substrate with a self-assembled metal mesh thereon having an opening size of about 20 to about 50 μm in said transparent conductive film, at least 75% visible light transmission and a sheet resistance of not greater than 10 ohms/square being fabricated according to claim 1.
